(19) United States
(12) Patent Application Publication
(10) Pub. No.: US 2024/0428160 A1
(43) Pub. Date: Dec. 26, 2024

(54) ASSET WORKFLOW MANAGEMENT

(71) Applicant: HONEYWELL INTERNATIONAL INC., Charlotte, NC (US)

(72) Inventors: Yadunandan B.C, Bangalore (IN); Perminder Singh, Bangalore (IN); Nivas Sekar, Bangalore (IN); Girish Venkatasubbarao, Bangalore (IN)

(21) Appl. No.: 18/212,181

(22) Filed: Jun. 21, 2023

(51) Int. Cl. G06Q 10/0633

(52) U.S. Cl. CPC G06Q 10/0633

(57) ABSTRACT

Techniques for asset workflow management are described. In one example implementation, the present subject matter facilitates in managing configuration changes of an asset in an industrial environment and further facilitates identification and managing resultant changes in a configuration data file corresponding to the asset in view of the configuration changes.

### BACKGROUND

Processing facilities, such as an industrial environment, are often managed using process and safety control systems. Example processing facilities include, but are not limited to, manufacturing plants, chemical plants, crude oil refineries, and ore processing plants. Among other operations, process and safety control systems typically manage the use-of industrial equipments in the processing facilities. To alter operating conditions of the industrial equipments, changes are periodically made into the existing configurations of the industrial equipments, and these changes get captured in a configuration datafile.

### SUMMARY OF INVENTION

This summary is provided to introduce concepts related to managing configuration changes of assets that are used in an industrial environment and for identifying and managing changes in an operational workflow file corresponding to the asset due to the configuration changes. This summary is not intended to identify essential features of the claimed subject matter nor is it intended for use in determining or limiting the scope of the claimed subject matter.

In an aspect of the present subject matter, a method for correcting any anomaly in historic operational data of at least one asset due to a change in existing configuration of the at least one asset is disclosed. The method includes receiving a configuration data update file having new configuration data corresponding to each of a plurality of assets operating in an industrial environment and generating a configuration change summary. The configuration change summary may indicate changes in existing configuration of the at least one asset from among the plurality of assets based on analysis of the new configuration data. The method further includes processing an operational workflow file corresponding to the at least one asset. The operational workflow file may be processed to determine any anomaly in historic operational data of the at least one asset due to the change in existing configuration of the at least one asset. The operational workflow file may include historic operational data of the at least one asset. Further, the historic operational data of the at least one asset may be updated in accordance to the new configuration data to correct the anomaly.

In another aspect of the present subject matter, a system for updating existing configuration of at least one asset with new configuration data in a configuration datafile of the at least one asset is disclosed. The system includes a summary generation engine and a workflow update engine. The summary generation engine may initially receive a configuration data update file having the new configuration data corresponding to each of a plurality of assets operating in an environment. The summary generation engine may then determine an upload setting of the configuration data update file. In one example, the upload setting may be one of a manual upload setting and an auto-upload setting. If the upload setting is the manual upload setting the summary generation engine may generate a configuration change summary on receiving a first prompt from a user. The configuration change summary may indicate change in existing configuration of at least one asset from among the plurality of assets, based on analysis of the new configuration data. If the upload setting is the auto-upload setting, the summary generation engine may auto generate the configuration change summary. Further, the workflow update engine may update the existing configuration of the at least one asset with the new configuration data in a configuration data file of the at least one asset. The configuration data file may comprise existing configuration data of the at least one asset and operational data of the at least one asset when operating according to the existing configuration data.

In yet another aspect of the present subject matter, a non-transitory computer readable medium for correcting any anomaly in historic operational data of at least one asset due to a change in existing configuration of the at least one asset is disclosed. The non-transitory computer readable medium has instructions stored thereon. The instructions, when executed by a processor, cause the processor to perform operations. In the operations, a change in existing operational control data of at least one process from among a plurality of processes operating in an industrial environment is determined. The determination is based on analysis of a new operational control data of the at least one process. Further, in operation, an operational workflow file associated with the at least one process is processed to determine any anomaly in the historic operational data of the at least one process due to the change in existing operational control data of the at least one process. The operational workflow file includes historic operational data of the at least one process. Yet further, in the operations, the historic operational data of the at least one process is updated in accordance with the new operational control data to correct the anomaly, and the existing operational control data is updated with the new operational control data in an operational control data file of the at least one process.

### BRIEF DESCRIPTION OF FIGURES

Systems and/or methods, in accordance with examples of the present subject matter are now described and with reference to the accompanying figures, in which:

FIG. 1 illustrates a system for updating existing configuration of an asset with new configuration data in an operational workflow file of the asset, according to an example;

FIG. 2 illustrates a network environment for updating existing configuration of an asset with new configuration data in an operational workflow file of the asset, according to an example;

FIG. 3 illustrates a method for correcting any anomaly in historic operational data of an asset due to a change in existing configuration of the at asset, according to an example;

FIG. 4 illustrates a method for correcting any anomaly in historic operational data of an asset due to a change in existing configuration of the at asset, according to another example;

FIG. 5 illustrates a flow diagram of a process of managing configuration changes of an asset in an industrial environment and identifying and managing changes in an operational workflow file corresponding to the asset due to the configuration changes, according to an example; and

FIG. 6 illustrates a non-transitory computer readable medium for correcting any anomaly in historic operational data of an asset due to a change in existing configuration of the asset, according to an example.

### DETAILED DESCRIPTION

Typically, processing facilities, such as industrial environment, managed by a process and safety control system that controls processes or assets, such as an industrial equipment, operating in the processing facilities and ensures that the assets or the processes operate safely in the processing facilities. In a processing facility, after operating over a period of time, changes are made in existing configurations of the assets or the processes for various reasons, such as to enhance performance output of the assets or the processes. Similar changes may also be made in a process and safety control system, for example, a process safety analyzer during operation of an asset to ensure that safety of the processing facility is not compromised due to the change to the existing configuration of the assets or the processes. However, when a change in existing configuration of an asset or a process is done in the process and safety control system, any anomaly arising in historic operational data of the asset or the process due to the change is not identified and operational data of the asset or the process may be archived with anomalies. The operational data of the asset or the process archived with anomalies may compromise the safety of the processing facility.

The present subject matter provides approaches for asset workflow management. In one example implementation, the present subject matter facilitates in managing configuration changes of an asset in an industrial environment. In an example, managing an asset includes maintaining and controlling apart from certain additional optional functionalities. The subject matter further facilitates identification and managing resultant changes in a configuration data file corresponding to the asset in view of the configuration changes. In one example, a configuration change summary may initially be generated to capture and indicate changes in existing configuration of the asset, upon receipt of new configuration data corresponding to each of a plurality of assets. Further, an operational workflow file corresponding to the asset may be processed to determine and correct any anomaly in historic operational data of the asset in view of the changes in existing configuration of the asset. The present subject matter thus not only facilities in identifying and updating configuration changes in the asset but also ensures that any anomaly arising in the operational workflow file due to the change in the existing configuration is identified and the historic operational data of the asset is corrected.

In an example, the present subject matter discloses receiving a configuration data update file having the new configuration data corresponding to each of the plurality of assets operating in an environment. The new configuration data may be an updated configuration data of any asset where changes are done by a user to configuration data of the asset for correcting operational parameter of the asset. In an example, the user may be a configuration user. The asset may be one of an industrial equipment, such as a boiler operating in an oil and gas plant and a process, such as a welding process operating in a vehicle manufacturing plant. For the asset being a process, the new configuration data may be new operational control data of the process, and the existing configuration may be existing operational control data of the process. Further, in an example, the environment may be a process facility, such as an industrial environment. Upon receiving the configuration data update file, the configuration change summary may be generated. In one example, the configuration change summary may include data indicating changes in existing configuration of an asset from among the plurality of assets.

In one example, the configuration change summary may be generated based on an upload setting of the configuration data file. The upload setting maybe one of a manual upload setting and an auto-upload setting. The manual upload setting may be defined as a setting as per which a user input may be required to execute any process step. The auto-upload upload setting may be defined as a setting as per which any process step may be automatically executed without requiring any user intervention. Based on the determined upload setting, the configuration change summary may be generated either on receiving a first prompt from a user for the upload setting determined as the manual upload setting or is auto generated for the upload setting determined as the auto-upload setting.

Once the configuration change summary is generated, an operational workflow file corresponding to the asset may be processed. The operational workflow file may be defined as a data file including historic operational data of the asset. In an example, the operational workflow file may be one of a dataset, a database in the form of a structured query language (SQL) file, a SQL file and an IDBA file. In an example, the operational workflow file may be in a tabular format. The historical operational data may indicate the operation data corresponding to the asset when the asset operated in accordance to the existing configuration data. The operational workflow file may be processed to determine any anomaly in historic operational data of the asset due to the change in existing configuration of the asset. In one example, the anomaly may indicate one or more such instances in historic operation where the asset was correctly operated in accordance to the existing configuration at that instance, but in view of the new configuration data, the asset is now determined to have been incorrectly operated at that instant. On determining such an anomaly, the historic operational data of the asset may be updated in accordance to the new configuration data to correct the anomaly. Such an update facilitates in ensuring that the historic operation of the asset does not contradict the current operation of the asset in view of the new configuration data. In addition, in an example, a configuration data file of the asset may be updated to include the new configuration data in place of the existing configuration of the asset. In an example, the configuration data file may include the existing configuration of the asset.

Accordingly, the present subject matter facilitates in processing of the operational workflow file to determine the anomaly and correction of the determined anomaly. Thus, the present subject matter provides an option to reanalyse the historic operational data for ensuring that the change in existing configuration of the asset is safe for the processing facilities, such as industrial environment. The present subject matter further facilitates in unanimous update of the historic operational data and the configuration data file so that the new configuration data is uniformly updated at all places relevant for the operation of the asset.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

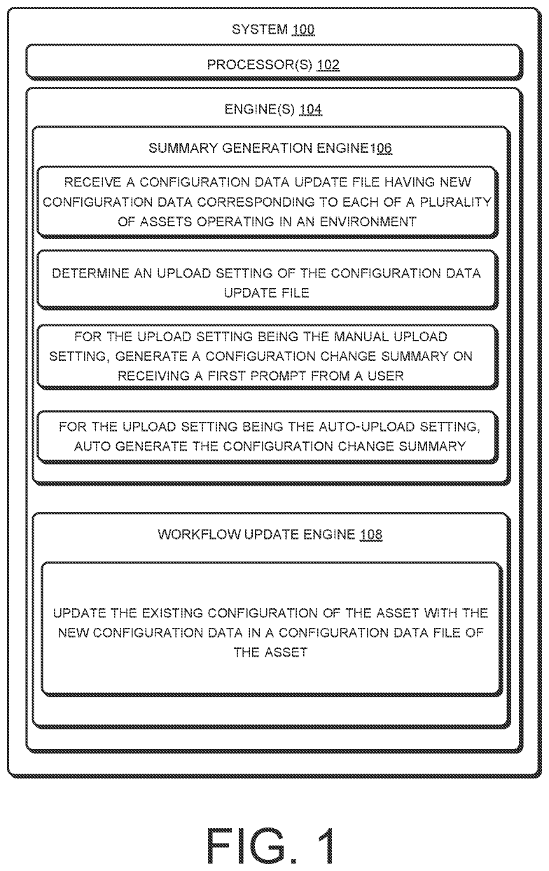

FIG. 1 illustrates a system 100 for updating existing configuration of an asset with new configuration data in a configuration data file of the asset, according to an example. Examples of the system 100 may include, but are not limited to, a laptop, a notebook computer, a server computer, a tablet computer, and a smartphone. The system 100 may include processor(s) 102. The processor(s) 102 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labelled as “processor(s)”, may be provided through the use of dedicated hardware as well as hardware capable of executing computer-readable instructions. In one example, the system 100 may be a standalone server or may be a remote server on a cloud computing platform. In a preferred example, the system 100 may be a cloud-based system. The system 100 is capable of delivering applications (such as cloud applications) for managing an industrial environment.

The system 100 may further include engine(s) 104. The engine(s) 104 may be implemented as a combination of hardware and programming, for example, programmable instructions to implement a variety of functionalities of the engine(s) 104. In examples described herein, such combinations of hardware and programming may be implemented in several different ways. For example, the programming for the engine(s) 104 may be executable instructions. Such instructions may be stored on a non-transitory machine-readable storage medium which may be coupled either directly with the system 100 or indirectly (for example, through networked means). In an example, the engine(s) 104 may include a processing resource, for example, either a single processor or a combination of multiple processors, to execute such instructions. In other examples, the engine(s) 104 may be implemented as electronic circuitry. The engine(s) 104 includes a summary generation engine 106 and a workflow update engine 108.

The asset may be one of an industrial equipment, such as a boiler operating an oil and gas plant and a process, such as a welding process operating in a vehicle manufacturing plant. Examples of industrial equipment may include, but is not limited to, relief valves, blowdown valves, dampers, breakers. An existing configuration of an asset is a vendor provided parameter on which the asset may operate safely. For example, in case the asset is an intake valve of a boiler, the intake valve to be closed after 10 minutes of starting of any process taking place in the boiler for ensuring safe operation of the boiler as per a usage manual of the intake valve, 10 minutes may be considered as the existing configuration of the intake valve.

In one example, the new configuration data may be defined as updated configuration data of any asset where changes may have been done to the configuration data of the asset, for example, by a user, for various reasons, such as for correcting operational parameter of the asset. For example, in case the asset is an intake valve of a boiler, the intake valve, it is possible that as per the current configuration, the intake valve may be closing after 10 minutes from the start of any process taking place in the boiler for ensuring safe operation of the boiler. However, it is possible that the intake valve may operate for up to 20 minutes from the start of any process without compromising the safe operation of the boiler, thus, 20 minutes may be considered as the new configuration data for shutting down of the intake valve.

The update from 10 minutes to 20 minutes may be done by the user for correcting the operational parameter of the intake valve to enhance the performance output of the boiler. In addition, such an operation of the asset that when the intake valve must get closed is based on a Cause and Effect Matrix. In the present example, operation of the intake valve till the 20th minute is the Cause and the closing of the intake valve on or after the 20th minute is the Effect. In another example, a safety logic implemented in an LPG storage may be illustrated for the Cause and Effect Matrix, where fire sensors mounted on the LPG Storage will be acting as the “Causes” and these are interfaced to Safety System via Input Sub System, the moment Safety System detects the fire signal or the “Cause”, it executes a control logic and generate commands or “Effects” to turn off the control valve supplying the gas from that storage and opening a water sprinkle valve on the top of the storage unit to create a safe water curtain.

In operation, the summary generation engine 106 of the system 100 may initially receive a configuration data update file having the new configuration data corresponding to each of the plurality of assets operating in an environment. The configuration data update file may be a bulk load data file that includes the new configuration data of each of the assets and processes operating in the environment. In an example, the environment may be a process facility, such as an industrial environment. Example processing facilities include, but are not limited to, manufacturing plants, chemical plants, crude oil refineries, and ore processing plants. As industrial environment refers to a processing environment comprising configurable computing physical and logical resources, for example, networks, servers, storage, applications, services, etc., and data distributed over a platform, such as cloud computing platform. The industrial environment provides on-demand network access to a shared pool of configurable computing physical and logical resources.

Upon receiving the configuration data update file, the summary generation engine 106 may determine an upload setting of the configuration data file. In one example, the upload setting may be one of a manual upload setting and an auto-upload setting. The manual upload setting may be defined as a setting as per which a user input may be required to execute any process step. The auto-upload setting may be defined as a setting as per which any process step may be automatically executed without requiring any user intervention.

On determining the upload setting as the manual upload setting, the summary generation engine 106 may generate a configuration change summary on receiving a first prompt from a user. In an example, the user may be a configuration user. In an example, the user may feed the configuration data update file for the generation of the configuration change summary. In one example, the user may actuate a toggle button on a display unit to generate the first prompt. The configuration change summary may include data that indicates change in existing configuration of an asset from among the plurality of assets. In an example, the change in existing configuration may be shown for more than one asset. In one example, the configuration change summary may be generated based on analysis of the new configuration data. To analyse the new configuration data, the summary generation engine 106 may compare the new configuration data of the asset with the existing configuration of the asset. The configuration change summary may thus include data indicating changes in the existing configuration of the asset. During operation of the assets or the processes in the environment, a user may have changed the existing configuration of one or more assets or processes based on his/her observations during the operations that the one or more assets or processes may operate safely with changed configuration, i.e., the new configuration data. In one example, the user may be a vendor providing configurations of assets or processes or a technician operating the assets or the processes. In an example, the user may be a configuration user.

On determining the upload setting as the auto-upload setting, the summary generation engine 106 may auto generate the configuration change summary. In an example, in the auto-upload setting, the summary generation engine 106 may pick the configuration data update file from a database where the configuration data update file is stored after being received by the summary generation engine 106. In an example, the pick of the configuration data update file from the database may be done by a conventionally known techniques. In one example, the configuration change summary may be rendered to a user, for example, the configuration change summary may be displayed on a display unit for the reference of the user. The user may parse the configuration change summary to ascertain the changes being made to one or more assets or processes.

In an example, change information of the existing configuration data of the asset in sheets of the configuration data update file may be uniquely captured in a high-performance data structure comprised of couple of dictionaries which tracks both the modified properties and non-modified properties along with few other properties. Each dictionary has a key as string which determines the property name in the sheets and has a value as a complex type keeping track of original value and new value. This data structure is uniformly used across all of the sheets for tracking change information and later used to generate parameters which are candidates for reanalyzing. Due to the data structure, anytime a new sheet can be accommodated with any number of properties in the summary generation engine 106. Moreover, the present invention ensures that any change is not required for accommodating new sheet as this is driven from the backend data structure entirely.

After generating the configuration change summary, the workflow update engine 108 of the system 100 may update the existing configuration of the asset with the new configuration data in a configuration data file of the asset. The configuration data file may include the existing configuration data of the asset. The workflow update engine 108 by such an update ensures that the configuration data file is always updated in view of the new configuration data so that the asset operates safely as per the new configuration data.

While the figures have been mainly described with reference to an asset, the present subject matter may be similarly implemented for different processes being executed in the facility.

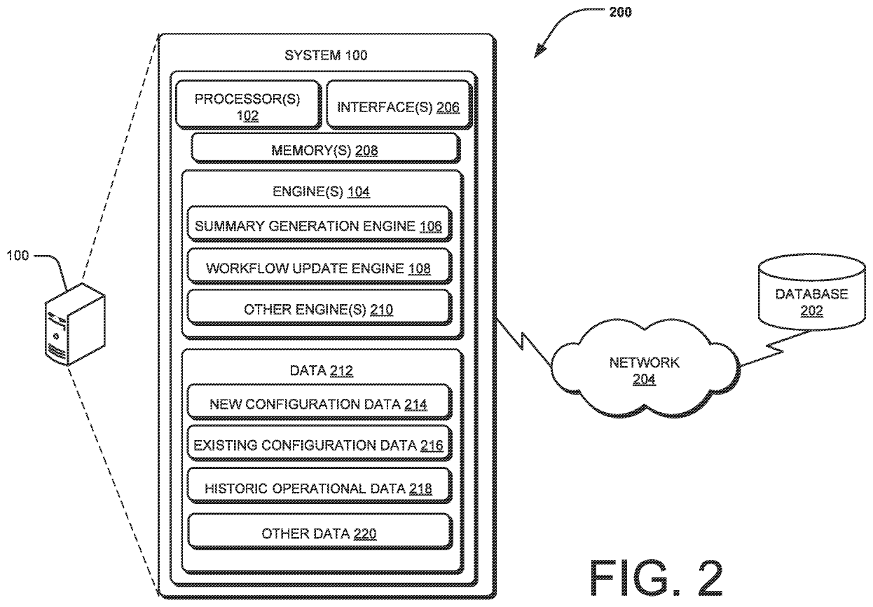

FIG. 2 illustrates a network environment 200 for updating existing configuration of an asset with new configuration data in a configuration data file of the asset, according to an example. The network environment 200 includes the system 100 for updating existing configuration of an asset with new configuration data in the configuration data file of the asset. In an example, the system 100 may be connected to a database 202 through a network 204. The database 202 may be, for example, a structured query language (SQL) data store or a not only SQL (NoSQL) data store. In an exemplary implementation, the database 202 may be configured as cloud-based database implemented in the industrial environment. In another exemplary implementation, the database 202 may be a location on a file system directly accessible by the engines. The database 202 may be configured to store engineering project files, program files, object behavior model, parameter values associated with the one or more assets and processes and the like.

The network 204 may be a wireless network, a wired network, or a combination thereof. The network 204 can also be an individual network or a collection of many such individual networks, interconnected with each other and functioning as a single large network, e.g., the Internet or an intranet. The network 204 can be implemented as one of the different types of networks, such as intranet, local area network (LAN), wide area network (WAN), the internet, and such. The network 204 may either be a dedicated network or a shared network, which represents an association of the different types of networks that use a variety of protocols, for example, Hypertext Transfer Protocol (HTTP). Transmission Control Protocol/Internet Protocol (TCP/IP), Wireless Application Protocol (WAP), etc., to communicate with each other.

In one implementation, the network environment 200 may be a company network, including thousands of office personal computers, laptops, various servers, such as blade servers, and other computing devices connected over the network 204. The system 100 includes the processor(s) 102. Further, the system 100 includes interface(s) 206 and memory(s) 208. The interface(s) 206 may allow the connection or coupling of the system 100 with one or more other devices, through a wired (e.g., Local Area Network, i.e., LAN) connection or through a wireless connection (e.g., Bluetooth®, Wi-Fi). The interface(s) 206 may also enable intercommunication between different logical as well as hardware components of the system 100.

The memory(s) 208 may be a computer-readable medium, examples of which include volatile memory (e.g., RAM), and/or non-volatile memory (e.g., Erasable Programmable read-only memory, i.e., EPROM, flash memory, etc.). The memory(s) 208 may be an external memory, or internal memory, such as a flash drive, a compact disk drive, an external hard disk drive, or the like. The memory(s) 208 may further include data which either may be utilized or generated during the operation of the system 100.

The system 100 may further include the engine(s) 104 and data 212. The engine(s) 104 includes the summary generation engine 106, the workflow update engine 108, and other engine(s) 210. The other engine(s) 210 may further implement functionalities that supplement functions performed by the system 100 or any of the engine(s) 210. In one example, the other engine(s) 210 may include a display engine (not shown) and a download engine (not shown). The data 212, on the other hand, includes data that is either stored or generated as a result of functions implemented by any of the engine(s) 104 or the system 100. It may be further noted that information stored and available in the data 212 may be utilized by the engine(s) 104 for performing various functions by the system 100. In an example, the data 212 may include new configuration data 214, existing configuration data 216, historic operational data 218, and other data 220. It may be noted that such examples are only indicative. The present approaches may be applicable to other examples without deviating from the scope of the present subject matter.

In operation, the summary generation engine 106 of the system 100 may receive a configuration data update file having the new configuration data corresponding to each of the plurality of assets operating in an environment. The configuration data update file is a bulk load data file that includes the new configuration data of each of the assets and processes operating in the environment. In an example, the environment may be a process facility, such as an industrial environment and is similar to the environment of FIG. 1. Example processing facilities include, but are not limited to, manufacturing plants, chemical plants, crude oil refineries, and ore processing plants. In one example, the summary generation engine 106 may obtain information pertaining to the configuration data update file from the database 202.

In one example, the summary generation engine 106 of the system 100 may further determine an upload setting of the configuration data update file on receiving the configuration data update file. The upload setting may be one of a manual upload setting and an auto-upload setting. The manual upload setting may be defined as a setting as per which a user input may be required to execute any process step. The auto-upload setting may be defined as a setting as per which any process step may be automatically executed without requiring any user intervention.

In one example, the summary generation engine 106 may generate the configuration change summary on receiving a first prompt from a user when the upload setting is determined as the manual upload setting. In one example, the summary generation engine 106 may auto generate the configuration change summary when the upload setting is determined as the auto-upload setting. The configuration change summary may include data that indicates change in existing configuration of an asset from among the plurality of assets. In one example, the configuration change summary may be generated based on analysis of the new configuration data.

In one example, the workflow update engine 108 may analyze an operational workflow file after generating the configuration change summary based on one of the manual upload setting and the auto-upload setting. The operational workflow file may be defined as a data file including historic operational data of the asset. In an example, the operational workflow file may be one of a dataset, a database in the form of a structured query language (SQL) file, a SQL file and an IDBA file. In an example, the operational workflow file may be in a tabular format. The historical operational data may indicate the operation data corresponding to the asset when the asset operated in accordance to the existing configuration data. The historical operational data provides history for both events and process data that is extracted from a variety of systems across multiple levels to quickly form a complete context of the environment.

In one example, for the manual upload setting, the workflow update engine 108 may perform the analysis of the operational workflow file corresponding to the asset upon receiving a second prompt from the user. In one example, the second prompt is separate from the first prompt. In one example, the user may trigger a single prompt to generate the first and the second prompts collectively. In an example, the first prompt may be one of a voice based prompt, an input device based prompt, and a touch based prompt. In an example, the second prompt may be one of a voice based prompt, an input device based prompt, and a touch based prompt.

The workflow update engine 108 may analyze the operational workflow file to determine any anomaly in historic operational data of the asset due to the change in existing configuration of the asset. In one example, the anomaly may indicate one or more such instances in historic operation where the asset was correctly operated in accordance to the existing configuration at that instance, but in view of the new configuration data, the asset is now determined to have been incorrectly operated at that instant. For example, in case the asset is an inlet valve and a warning time as per the new configuration data is 40 seconds, i.e., a warning signal must be generated if the inlet valve operates for equal to or more than 40 second. Accordingly, an instance, in the past, when the warning signal was generated after a lesser or a greater time, as the per the existing configuration, say 25 or 50 seconds of operation of the inlet valve, may be an anomaly in view of the new configuration data. In case any anomaly is not determined in the historic operational data, the operational workflow file may be considered as duly updated in accordance the new configuration data.

In further operation, the workflow update engine 108 may update the historic operational data of the asset in accordance to the new configuration data to correct the anomaly upon determination of the anomaly. The workflow update engine 108 by such an update ensures that the historic operation of the asset does not contradict the current operation of the asset in view of the new configuration data. Also, the updated historic operational data of the asset ensures that the asset operates safely as per the new configuration data.

In one example, the workflow update engine 108 may auto update the historic operational data of the at asset in accordance to the new configuration data to correct the anomaly. In one example, the workflow update engine 108 may update the historic operational data of the at asset in accordance to the new configuration data to correct the anomaly in response to receiving a third prompt from the user. In one example, the third prompt may be separate from the first prompt and the second prompt. In one example, the user may trigger a single prompt to generate the first, second, and third prompts collectively. In an example, the third prompt is one of a voice-based prompt, an input device based prompt, and a touch based prompt.

In an example, the display engine coupled to the summary generation engine 106 may display the configuration change summary of the asset on the display unit coupled to the display engine on receiving a fourth prompt from the user. In an example, the fourth prompt is one of a voice-based prompt, an input device based prompt, and a touch based prompt.

In an example, the display engine coupled to the summary generation engine 106 may display the configuration change summary of the asset on the display unit coupled to the display engine on receiving a fourth prompt from the user. In an example, the fourth prompt is one of a voice-based prompt, an input device based prompt, and a touch based prompt.

In an example, the download engine coupled to the workflow update engine 108 download the configuration data update file in a prespecified format. In one example, the prespecified format may be one of a PDF format and an excel format. The downloaded configuration data update file may be kept in the memory 208 for later use by the processor 102 for any analysis to ascertain the periodic changes done on configurations of any asset.

In an example implementation, the system 100 may be a process safety analyzer. The process safety analyzer is a suite of a shutdown analyzer and a safety element scout application. The shutdown analyzer and the safety element scout application are used to safely control the assets and contain the processes in the industrial environment, referred to as plant hereinafter in this paragraph. The process safety analyzer is used to verify whether the process plant shutdown sequences and safety elements are functioning as expected. A plant historian provides history for both events and process data and extracts the data from a variety of systems across multiple levels to quickly form a complete context of a manufacturing environment in the plant. The data collected in the plant historian is periodically monitored by process safety analyzer and is updated as per the present subject matter for the safe and efficient control and operation of the assets and the processes in the plant.

The present subject matter therefore ensures that the change in existing configuration of the asset is not compromising the safety of the industrial environment by facilitating the processing of the operational workflow file to determine any anomaly in historic operational data of the asset due to the change in existing configuration. In an example, the anomaly may be an incorrect or unsafe operation of the asset. The historic operational data of the asset is updated in accordance with the new configuration data to correct the anomaly. Therefore, the processing of the operational workflow file to determine the anomaly and correction of the determined anomaly by updating the historic operational data ensures that the change in existing configuration of the asset is safe for the industrial environment.

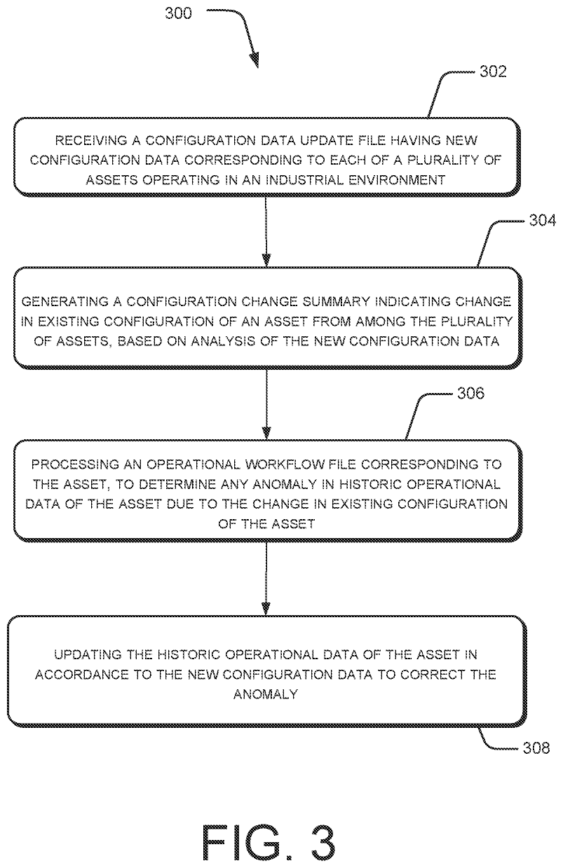

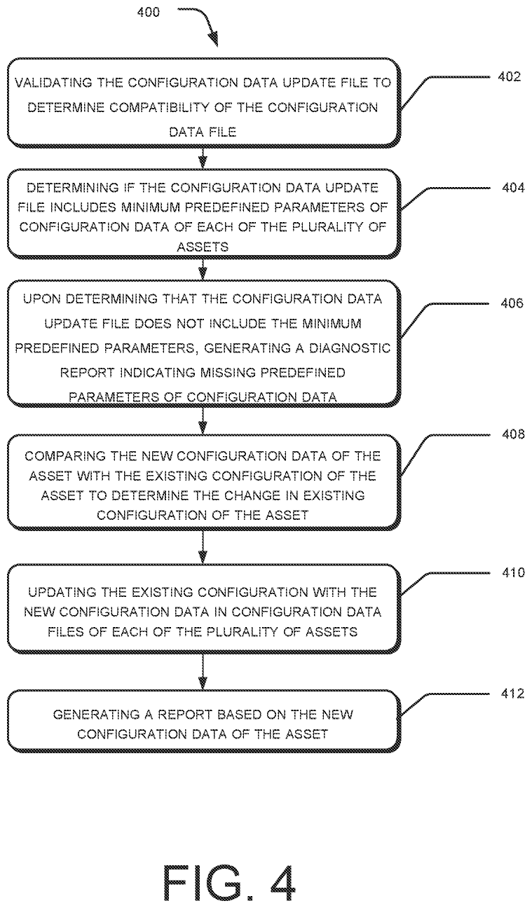

FIGS. 3 and 4 illustrate methods 300 and 400 for correcting any anomaly in historic operational data of at least one asset due to a change in existing configuration of the at least one asset, according to an example. The order in which the above-mentioned methods are described is not intended to be construed as a limitation, and some of the described method blocks may be combined in a different order to implement the method, or an alternative method.

Furthermore, the above-mentioned methods may be implemented in a suitable hardware, computer-readable instructions, or combination thereof. The steps of such methods may be performed by either a system under the instruction of machine executable instructions stored on a non-transitory computer readable medium or by dedicated hardware circuits, microcontrollers, or logic circuits. Herein, some examples are also intended to cover non-transitory computer readable medium, for example, digital data storage media, which are computer readable and encode computer-executable instructions, where the instructions perform some or all the steps of the above-mentioned methods.

Referring to FIG. 3, the method 300 may be implemented by a system for for updating existing configuration of an asset with new configuration data in a configuration data file of the asset. The asset may be similar to the asset of FIG. 1. The existing configuration of the asset may be similar to the existing configuration of FIG. 1. The new configuration data may be similar to the new configuration data of FIG. 1. The configuration data file may be similar to the configuration data file of FIG. 1.

At block 302, the method includes receiving a configuration data update file having new configuration data corresponding to each of a plurality of assets operating in an industrial environment. The configuration data update file is similar to the configuration data update file of FIG. 1. Example industrial environment include, but is not limited to, manufacturing plants, chemical plants, crude oil refineries, and ore processing plants. In one example, a user may upload the configuration data update file on the system 100.

At block 304, a configuration change summary may be generated. In one example, the configuration change summary may include the changes in existing configuration of the asset from among the plurality of assets. The changes may be determined based on analysis of the new configuration data. In an example, the changes in existing configuration may be shown for more than one asset. The configuration change summary may be generated based on analysis of the new configuration data. To analyse the new configuration data, the new configuration data of the asset may be compared with the existing configuration of the asset. For example, if the asset is a safety valve of a boiler, which actuates when pressure inside the boiler reached a preset value. If existing configuration of the preset value is 20 bar and new configuration data of the preset value is 30 bar, while generating the configuration change summary, the fact that the preset value is changed from 20 bar to 30 bar will be captured in the configuration change summary and may be shown to a user on request.

At block 306, an operational workflow file corresponding to the asset may be processed. In one example implementation, the operational workflow file may be processed to determine any anomaly in historic operational data of the at asset due to the change in existing configuration of the asset. In one example, the operational workflow file may include the historic operational data of the asset. The historical operational data may indicate the operation data corresponding to the asset when the asset operated in accordance to the existing configuration data. The historical operational data provides history for both events and process data that is extracted from a variety of systems across multiple levels to quickly form a complete context of the environment. In one example, the anomaly may indicate one or more such instances in historic operation where the asset was correctly operated in accordance to the existing configuration at that instance, but in view of the new configuration data, the asset is now determined to have been incorrectly operated at that instant. In one example, the anomaly is an incorrect operation of an asset. In one example, the anomaly is an incorrect output of an asset. In case any anomaly is not determined in the historic operational data, any update in the historic operational data is not required.

At block 308, the historic operational data of the asset may be updated in accordance to the new configuration data, to correct the anomaly. The historic operational data of the asset is updated for ensuring that the historic operation of the asset does not contradict the current operation of the asset in view of the new configuration data. Also, the updated historic operational data of the asset ensures that the asset operates safely as per the new configuration data.

At block 402, the configuration data update file may be validated to determine compatibility of the configuration data update file. In an example implementation, the compatibility determination is a basic sanity check that may be performed to ascertain that the configuration data update file is processable by the system 100. In one example, the configuration data update file may be validated by a preliminary check to verify that the configuration data update file is in a predefined format. In an example, predefined format may be a structure of the file. In one example, if the system 100 accepts files in PDF format, then the predefined format is the PDF format. Examples of the predefined format includes, but is not limited to, a PDF format and an excel format. In one example, the predefined format may be a size of the configuration data update file. For example, if any configuration data update file is larger than 100 MB but smaller than 150 MB may be of a predefined format. Examples of the predefined format is not limited to the size of the configuration data update file, other parameters may also be considered to define the predefined format of the configuration data file.

At block 404, to further validate the configuration data update file, it may be determined if the configuration data update file includes minimum predefined parameters of configuration data of each of the plurality of assets. In one example, every asset has a minimum set of parameters of configuration data specified by the vendor of the asset or the manufacturer of the asset that are mandatory to be verified for the operational check of the asset. In an example, minimum predefined parameters may be minimum Parameters such as safety devices operational setting change or relationship between safety inputs with safety Operation, interdependency with safety logic grouping.

At block 406, a diagnostic report may be generated upon determining that the configuration data update file does not include the minimum predefined parameters. In an example, the diagnostic report may indicate missing predefined parameters of configuration data. In an example, based on the generated diagnostic report, the configuration data update file may be updated to include the missing predefined parameters of configuration data. The configuration data update file inclusive of the parameters which were missing earlier can be revalidated to determine if the updated configuration data update file includes minimum predefined parameters of configuration data of each of the plurality of assets. The validated configuration data update file may then be utilized for the configuration change summary generation.

At block 408, for generating the configuration change summary based on the validated configuration data update file, the new configuration data of the asset may be compared with the existing configuration of the asset to determine the change in existing configuration of the asset. In an example, the comparison may be a basic mathematical process to find the differences in two quantities, which in the present instance are the new configuration data and the existing configuration. The differences in two quantities are showcased as the configuration change summary. In an example, predefined queries may be executed for comparing the new configuration data of the asset with the existing configuration of the asset.

In an example, in the method 400, prior to generation of the configuration change summary, an upload setting of the configuration data update file may be determined as one of a manual upload setting and an auto-upload setting. For the upload setting determined as the manual upload setting, the configuration change summary may be generated on receiving a first prompt from a user. In case the configuration change summary is generated based on the first prompt from the user, the configuration change summary may be viewed by the user on a display before uploading the configuration data update file. For the upload setting determined as the auto-upload setting, the configuration change summary may be auto generated, and the configuration data update file is auto uploaded post configuration change summary generation. In one example, the configuration change summary may be auto generated but the configuration data update file is uploaded only on receiving a user input.

At block 410, the existing configuration may be updated with the new configuration data in configuration data files of each of the plurality of assets. In one example, for updating the existing configuration with the new configuration data, the existing configuration may be rewritten with the new configuration data in the configuration data file of the asset. In other words, the existing configuration may be replaced with the new configuration data in the configuration data file of the asset. By doing so, the asset may consider the new configuration data for the operation for enhanced performance output.

At block 412, a report may be generated based on the new configuration data of the asset. In one example, the generated report may be stored in a database for any future audit of the asset. In one example, the generated report may be an excel sheet. Since the existing configuration is replaced with the new configuration data in the configuration data file of the asset, retrieval of old data is only possible by such a report generation and storing the generated report.

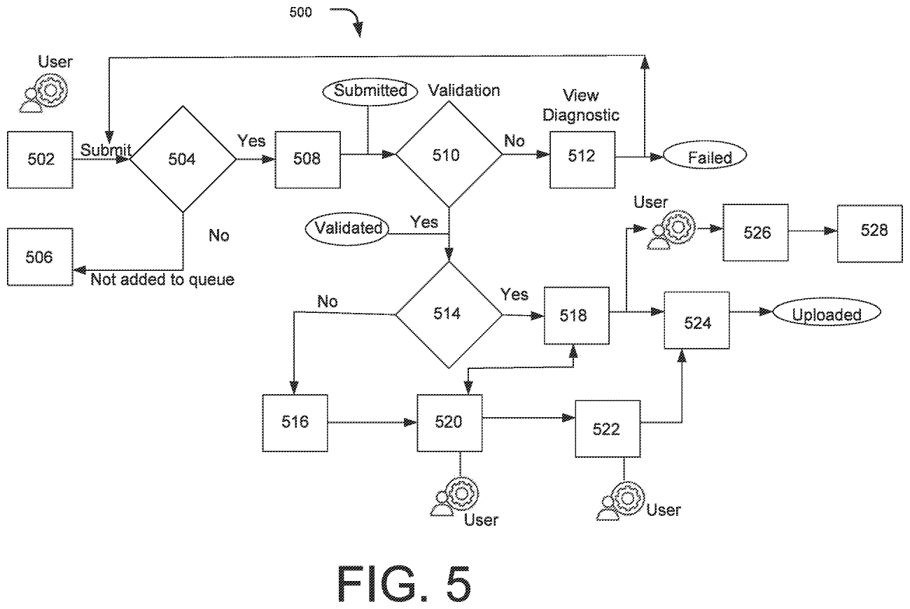

FIG. 5 illustrates a flow diagram of a process 500 of managing configuration changes of an asset in an industrial environment, according to an example. The order in which the above-mentioned process is described is not intended to be construed as a limitation, and some of the described process blocks may be combined in a different order to implement the process, or an alternative process.

Furthermore, the above-mentioned process may be implemented in a suitable hardware, computer-readable instructions, or combination thereof. The steps of such process may be performed by either a system under the instruction of machine executable instructions stored on a non-transitory computer readable medium or by dedicated hardware circuits, microcontrollers, or logic circuits. Herein, some examples are also intended to cover non-transitory computer readable medium, for example, digital data storage media, which are computer readable and encode computer-executable instructions, where the instructions perform some or all the steps of the above-mentioned methods. In an example, the process 500 may be implemented by the system 100 of FIGS. 1 and 2.

At block 502, a configuration data update file may be received. The configuration data update file may include new configuration data corresponding to each of a plurality of assets operating in an industrial environment. In one example, a user may upload the configuration data update file on the system 100. In an example, the user may be a configuration user. In one example, the configuration data update file may be automatically received at the system 100 based on a set automated process. In an example, the system 100 is a process safety analyser that automates the process of validating process safety systems to continuously ensure process safety. The process safety analyzer may provide automated tracking, recording and validation on the condition of safety instrumented systems and final elements, with views and reports for analyzing their current and past condition and helping to quickly identify areas of attention for testing or maintenance. In an example, the process safety analyzer may focus on safety instrumented systems and validates that all recorded operations were executed as expected in a timely manner. In an example, the process safety analyzer may focus on final elements keeping track of all operations and validates that these occur as expected. In an example, the process safety analyzer may gather key performance indicators for automatically generating reports to support on the safety systems.

At block 504, the configuration data update file may be validated to determine compatibility of the configuration data update file. The compatibility determination is a basic sanity check that may be performed to ascertain that the configuration data update file is processable by the system 100. In one example, the compatibility determination is to verify that the configuration data update file is in a predefined format. Examples of the predefined format includes, but is not limited to, a PDF format and an excel format. If the configuration data update file is determined as validated, i.e., Yes, the configuration data update file is moved to block 508. If the configuration data update file is determined as not validated, i.e., No, the configuration data update file is moved to block 506 with a status “not added to queue”.

At block 506, the results may be generated to showcase the reasons for non-compatibility and accordingly corrective measures may be taken to correct the format of the configuration data update file so that the system 100 may validate the corrected configuration data update file.

At block 508, the configuration data update file may be added to queue for the validation test. In an example, a plurality of configuration data update files may be added to the queue and the system 100 process the configuration data update files based on a chronological order. When the configuration data update file is submitted after the passing a waiting time in the queue, the configuration data update file moves to block 510.

At block 510, the configuration data update file may be further validated to determine if the configuration data update file includes minimum predefined parameters of configuration data of each of the plurality of assets. In one example, every asset has a minimum set of parameters of configuration data specified by the vendor of the asset or the manufacturer of the asset that are mandatory to be verified for the operational check of the asset. In an example, minimum predefined parameters may be minimum Parameters such as safety devices operational setting change or relationship between safety inputs with safety Operation, interdependency with safety logic grouping. If the configuration data update file is determined as further validated, i.e., Yes, the configuration data update file is moved to block 514. If the configuration data update file is determined as not validated, i.e., No, the configuration data update file is moved to block 512 with a status “not validated”.

At block 512, a diagnostic report may be generated. In an example, the diagnostic report may indicate missing predefined parameters of configuration data. In an example, based on the generated diagnostic report, the configuration data update file may be updated to include the missing predefined parameters of configuration data. The updated configuration data update file may be resubmitted at block 504 for the sanity check. The configuration data update file inclusive of the parameters which were missing earlier can be revalidated to determine if the updated configuration data update file includes minimum predefined parameters of configuration data of each of the plurality of assets. The validated configuration data update file may then be utilized for the configuration change summary generation.

At block 514, an upload setting of the configuration data update file may be determined. If the upload setting is determined as a manual upload setting, i.e., No, the configuration data update file moves to block 516. If the upload setting is determined as a auto-upload setting, i.e., Yes, the configuration data update file moves to block 518. In an example, the manual upload setting may be defined as a setting as per which a user input may be required to execute any process step. In an example, the auto-upload setting may be defined as a setting as per which any process step may be automatically executed without requiring any user intervention.

At block 516, a configuration change summary may be generated on receiving a first prompt from a user. In one example, the user may actuate a toggle button on a display unit to generate the first prompt. The configuration change summary may include data that indicates change in existing configuration of an asset from among the plurality of assets. In an example, the change in existing configuration may be shown for more than one asset. In one example, the configuration change summary may be generated based on analysis of the new configuration data. To analyse the new configuration data, the new configuration data of the asset is compared, at block 516, with the existing configuration of the asset. The configuration change summary may thus include data indicating changes in the existing configuration of the asset. During operation of the assets or the processes in the environment, a user may have changed the existing configuration of one or more assets or processes based on his/her observations during the operations that the one or more assets or processes may operate safely with changed configuration, i.e., the new configuration data. In one example, the user may be a vendor providing configurations of assets or processes or a technician operating the assets or the processes.

At block 520, the configuration change summary may be rendered on receiving a second prompt from the user. In one example, the user may actuate a toggle button on the display unit to generate the second prompt. In one example, the configuration change summary may be rendered to the user, for example, the configuration change summary may be displayed on a display unit for the reference of the user. The user may parse the configuration change summary to ascertain the changes being made to one or more assets or processes.

At block 522, the configuration data update file may be uploaded in a database on receiving a third prompt from the user. In one example, the user may actuate a toggle button on the display unit to generate the third prompt. The upload of the configuration data update file is to update the existing configuration data with the new configuration data in a configuration data file of the asset. In an example, the configuration data file may include the existing configuration data of the asset.

At block 518, when the upload setting is determined as the auto-upload setting, the configuration change summary may be auto generated. In one example, the configuration change summary may be rendered to a user, for example, the configuration change summary may be displayed on a display unit for the reference of the user. The user may parse the configuration change summary to ascertain the changes being made to one or more assets or processes.

At block 524, the configuration data update file may be auto-uploaded in a database. The upload of the configuration data update file is to update the existing configuration data with the new configuration data in the configuration data file of the asset. In an example, the configuration data file may include the existing configuration data of the asset.

Intermittently during the auto-upload setting, at block 526, the configuration change summary may be rendered to the user, for example, the configuration change summary may be displayed on a display unit for the reference of the user.

Further, at block 528, an operational workflow file may be reanalysed. The reanalysis may be carried out by processing the operational workflow file to determine any anomaly in historic operational data of the at asset due to the change in existing configuration of the asset. In one example, the operational workflow file may include the historic operational data of the asset. The historical operational data may indicate the operation data corresponding to the asset when the asset operated in accordance to the existing configuration data. The historical operational data provides history for both events and process data that is extracted from a variety of systems across multiple levels to quickly form a complete context of the environment. In one example, the anomaly may indicate one or more such instances in historic operation where the asset was correctly operated in accordance to the existing configuration at that instance, but in view of the new configuration data, the asset is now determined to have been incorrectly operated at that instant. In one example, the anomaly is an incorrect operation of an asset. In one example, the anomaly is an incorrect output of an asset. In case any anomaly is not determined in the historic operational data, the historic operational data does not require any update. Further, at block 528, the historic operational data of the asset may be updated in accordance to the new configuration data, to correct the anomaly. The historic operational data of the asset is updated for ensuring that the historic operation of the asset does not contradict the current operation of the asset in view of the new configuration data.

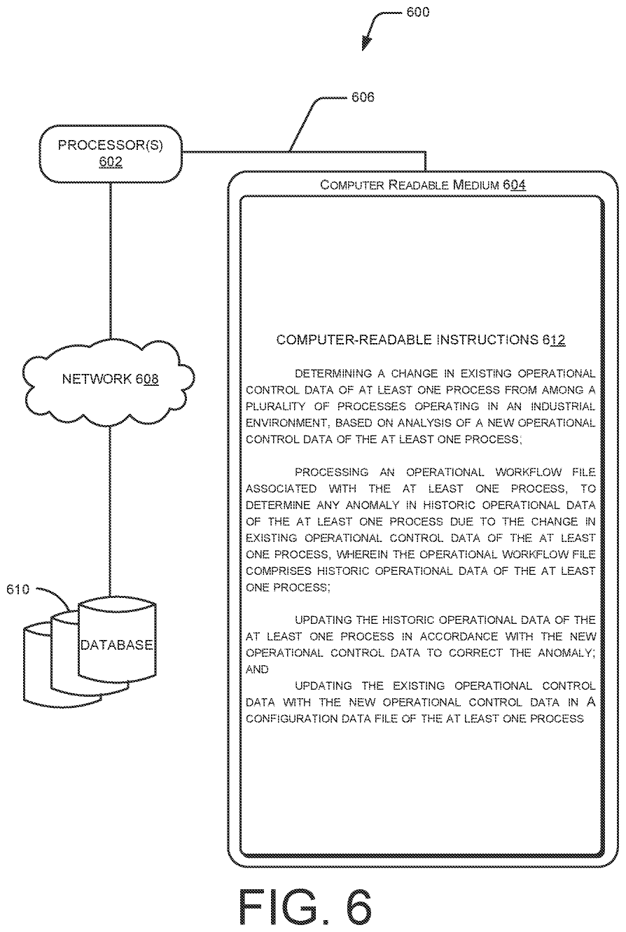

FIG. 6 illustrates a system environment 600 implementing a non-transitory computer readable medium for correcting any anomaly in historic operational data of an asset due to a change in existing configuration of the asset, according to an example. In an example, the system environment 600 includes processor(s) 602 communicatively coupled to a non-transitory computer readable medium 604 through a communication link 606. In an example, the processor(s) 602 may have one or more processing resources for fetching and executing computer-readable instructions from the non-transitory computer readable medium 604. The processor(s) 602 and the non-transitory computer readable medium 604 may be implemented, for example, in the system 100 (as has been described in conjunction with the preceding figures).

The non-transitory computer readable medium 604 may be, for example, an internal memory device or an external memory device. In an example implementation, the communication link 606 may be a network communication link. The processor(s) 602 may access the non-transitory computer readable medium 604 through a network 608. The network 608 may be a single network or a combination of multiple networks and may use a variety of communication protocols. The processor(s) 602 and the non-transitory computer readable medium 604 may also be communicatively coupled to a data source 610 over the network 608. The data source 610 may include, for example, a database.

In an example implementation, the non-transitory computer readable medium 604 includes a set of computer readable instructions (hereinafter may also be referred as instructions) 612 which may be accessed by the processor(s) 602 through the communication link 606. Referring to FIG. 6, in an example, the non-transitory computer readable medium 604 includes instructions 612 that may cause the processor(s) 602 to determine a change in existing operational control data of a process from among a plurality of processes operating in an industrial environment similar to the environment of FIG. 1. Example industrial environment includes, but are not limited to, manufacturing plants, chemical plants, crude oil refineries, and ore processing plants. The process may be an operation such as a welding process operating in the industrial environment, such as a vehicle manufacturing plant. The existing configuration of the process may be a vendor provided parameter on which the process may operate safely. Further, the change may be determined based on analysis of a new operational control data of the process. In an example, for performing the analysis, the new operational control data of the process may be compared with the existing operational control data of the process to determine the change in existing operational control data of the process. The new operational control data may be defined as an updated operational control data of any process where changes may have been done to the operational control data of the process, for example, by a user, for various reasons, such as for correcting operational parameter of the asset

Further, the instructions 612 may cause the processor(s) 602, to process an operational workflow file associated with the process for determining any anomaly in historic operational data of the at process due to the change in existing operational control data of the process. In an example, the operational workflow file may include historic operational data of the process. In an example, the anomaly may indicate one or more instances in the historic operation where the asset was correctly executed in accordance to the existing configuration, but the asset is determined to have been incorrectly operated in view of the new configuration data. In an example, the instructions 612 may cause the processor(s) 602 to receive a user input to initiate the processing of the operational workflow file associated to the process. In another example, the instructions 612 may cause the processor(s) 602 to auto initiate the processing of the operational workflow file associated to the process. Thereafter, the instructions 612 may cause the processor(s) 602, to update the historic operational data of the process in accordance with the new operational control data to correct the anomaly.

Further, the instructions 612 may cause the processor(s) 602, to update the existing operational control data with the new operational control data in an operational control data file of the process. The update in the historic operational data of the process in the operational workflow file of the process and the update in the existing operational control data with the new operational control data in the operational control data file of the process facilitate in unanimous update of the historic operational data and the operational control data so that the new operational control data is uniformly updated at all places relevant for the operation of the asset.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

We claim:

1. A method comprising:
receiving a configuration data update file having new configuration data corresponding to each of a plurality of assets operating in an industrial environment;
generating a configuration change summary indicating change in existing configuration of at least one asset from among the plurality of assets, based on analysis of the new configuration data;
processing an operational workflow file corresponding to the at least one asset, to determine any anomaly in historic operational data of the at least one asset due to the change in existing configuration of the at least one asset, wherein the operational workflow file comprises historic operational data of the at least one asset; and
updating the historic operational data of the at least one asset in accordance to the new configuration data to correct the anomaly.

2. The method as claimed in claim 1, wherein the method comprises updating the existing configuration with the new configuration data in configuration data files of each of the plurality of assets.

3. The method as claimed in claim 2, wherein the updating comprises rewriting the existing configuration with the new configuration data in the configuration data file of the at least one asset.

4. The method as claimed in claim 1, wherein the anomaly indicates one or more instances in the historic operation where the asset was correctly executed in accordance to the existing configuration, but the asset is determined to have been incorrectly operated in view of the new configuration data.

5. The method as claimed in claim 1, wherein the generating a configuration change summary comprises comparing the new configuration data of the at least one asset with the existing configuration of the at least one asset to determine the change in existing configuration of the at least one asset.

6. The method as claimed in claim 1, wherein the method comprises validating the configuration data update file to determine compatibility of the configuration data file.

7. The method as claimed in claim 6, wherein the validating comprises a preliminary check to verify that the configuration data update file is in a predefined format.

8. The method as claimed in claim 7, wherein the validating comprises:
determining if the configuration data update file includes minimum predefined parameters of configuration data of each of the plurality of assets; and
upon determining that the configuration data update file does not include the minimum predefined parameters, the method comprises generating a diagnostic report indicating missing predefined parameters of configuration data.

9. The method as claimed in claim 1, wherein the generating a configuration change summary comprises:
determining an upload setting of the configuration data update file, the upload setting being one of a manual upload setting and an auto-upload setting;
for the upload setting being the manual upload setting, generating the configuration change summary on receiving a first prompt from a user; and
for the upload setting being the auto-upload setting, auto generate the configuration change summary.

10. The method as claimed in claim 1, wherein the method comprises generating a report based on the new configuration data of the at least one asset.

11. A system comprising:
a summary generation engine to
receive a configuration data update file having new configuration data corresponding to each of a plurality of assets operating in an environment; and
determine an upload setting of the configuration data update file, the upload setting being one of a manual upload setting and an auto-upload setting;
for the upload setting being the manual upload setting,
generate a configuration change summary on receiving a first prompt from a user, wherein the configuration change summary indicates change in existing configuration of at least one asset from among the plurality of assets, based on analysis of the new configuration data; and
for the upload setting being the auto-upload setting,
auto generate the configuration change summary; and
a workflow update engine to
update the existing configuration of the at least one asset with the new configuration data in a configuration data file of the at least one asset, wherein the configuration data file comprises existing configuration data of the at least one asset.

12. The system as claimed in claim 11, wherein the workflow update engine is to:
analyze an operational workflow file corresponding to the at least one asset, to determine any anomaly in historic operational data of the at least one asset due to the change in existing configuration of the at least one asset, wherein the operational workflow file comprises historic operational data of the at least one asset; and
update the historic operational data of the at least one asset in accordance to the new configuration data to correct the anomaly.

13. The system as claimed in claim 11, wherein for the upload setting being the manual upload setting, the workflow update engine is to perform the analysis of the operational workflow file corresponding to the at least one asset upon receiving a second prompt from the user.

14. The system as claimed in claim 11, wherein for the upload setting being the manual upload setting, the workflow update engine is to update the historic operational data of the at least one asset in accordance to the new configuration data to correct the anomaly in response to receiving a third prompt from the user.

15. The system as claimed in claim 11, wherein the system comprises a display engine to display the configuration change summary of the at least one asset on a display unit coupled to the display engine.

16. The system as claimed in claim 11, wherein the system comprises a download engine to download the configuration data update file in a prespecified format.

17. A non-transitory computer readable medium having instructions stored thereon, the instructions, when executed by a processor, cause the processor to perform operations comprising:
determining a change in existing operational control data of at least one process from among a plurality of processes operating in an industrial environment, based on analysis of a new operational control data of the at least one process;
processing an operational workflow file associated with the at least one process, to determine any anomaly in historic operational data of the at least one process due to the change in existing operational control data of the at least one process, wherein the operational workflow file comprises historic operational data of the at least one process when executed according to the existing operational control data;
updating the historic operational data of the at least one process in accordance with the new operational control data to correct the anomaly; and
updating the existing operational control data with the new operational control data in a operational control data file of the at least one process.

18. The non-transitory computer readable medium as claimed in claim 17, wherein the analysis comprises comparing the new operational control data of the at least one process with the existing operational control data of the at least one process to determine the change in existing operational control data of at least one process.

19. The non-transitory computer readable medium as claimed in claim 17, wherein the anomaly indicates one or more instances in the historic operation where an asset was correctly executed in accordance to the existing operational control data, but the asset is determined to have been incorrectly operated in view of the new operational control data.

20. The non-transitory computer readable medium as claimed in claim 17, wherein the instructions, when executed by the processor, cause the processor to perform operations comprising:
receiving a user input to initiate the processing of the operational workflow file associated to the at least one process.
